(19) United States
(12) Patent Application Publication
(10) Pub. No.: US 2017/0370203 A1
(43) Pub. Date: Dec. 28, 2017

(54) Stick-Slip Reduction Using Combined Torsional and Axial Control

(71) Applicant: Nabors Drilling Technologies USA, Inc., Houston, TX (US)

(72) Inventor: Mahmoud Hadi, Richmond, TX (US)

(21) Appl. No.: 15/195,534

(22) Filed: Jun. 28, 2016

(51) Int. Cl. E21B 44/04; G01L 3/10; E21B 47/00; G05B 15/02; E21B 4/02; E21B 3/02; E21B 45/00; E21B 19/00; E21B 21/08

(52) U.S. Cl. CPC E21B 44/04; E21B 4/02; G01L 3/10; E21B 47/0006; E21B 3/02; G05B 15/02; E21B 19/008; E21B 21/08; E21B 45/00

(57) ABSTRACT

The aspects described herein assist in mitigating vibrations arising from torsional energy accumulating on a drill string in a wellbore during drilling operations. A first sensor obtains torque measurement data at or near the top drive of the drilling rig. A second sensor may obtain weight on bit information. The controller receives the measured data, combines it with a first gain to obtain a first output value and a second gain to obtain a second output value. The first output value is provided to the top drive to adjust a speed of operation of the top drive, and the second output value is provided to the axial drive providing motion along a vertical axis of the drilling rig to adjust a speed of the vertical motion. In combination, the adjustments to the top drive and axial drive movements mitigate stick-slip in an automated manner more effectively than either individually.

### TECHNICAL FIELD

The present disclosure is directed to systems, devices, and methods for mitigating stick-slip. More specifically, the present disclosure is directed to systems, devices, and methods for combining both torsional and axial control of a drill string in order to mitigate stick-slip.

### BACKGROUND OF THE DISCLOSURE

Underground drilling involves drilling a bore through a formation deep in the Earth using a drill bit connected to a drill string. During rotary drilling, the torque applied at a top drive of a drilling rig is often out of phase with the rotational movement at the bottom-hole assembly (BHA) of the drill string due to an elasticity of the material of the drill string. This causes the drill string to yield somewhat under the opposing loads imposed by the rotational force at the top drive and friction/inertia at the end where the bit is located (e.g., the BHA). This causes resonant motion to occur between the top drive and the BHA that is undesirable. Further, as the drill string winds up along its length due to the ends being out of phase, the torque stored in the winding may exceed any static friction, causing the drill string near the bit to slip relative to the wellbore sides at a high (and often damaging) speed.

Measured torque of the drill string may be used in addition to other techniques to adjust a rotation speed during the rotary drilling to reduce the chance of stick-slip and/or other vibrations. In an approach, impedance between the top drive and the drill string (i.e., any torsional waves traveling up the drill string) is sought to be matched by analyzing rotations per minute (RPM) feedback from an encoder of a motor (e.g., a motor in a top drive or rotary table). As a result, the drive (e.g., a variable-frequency drive) is detuned to achieve as near to a constant torque as possible, resulting in changes to RPM of the top drive. Another approach is more active in changing speed to match impedance between the top drive and the drill string. The RPM value for the top drive is adjusted based on the feedback obtained from torque. These approaches can result in significant swings in top drive RPM speed, creating concern of damage to the drill string and the top drive when the swing is particularly large.

The present disclosure is directed to systems, devices, and methods that overcome one or more of the shortcomings of the prior art.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic of an apparatus shown as an exemplary drilling rig according to one or more aspects of the present disclosure.

FIG. 2 is a block diagram of an apparatus shown as an exemplary control system according to one or more aspects of the present disclosure.

FIG. 3 is a block diagram of an apparatus shown as an exemplary control system flow according to one or more aspects of the present disclosure.

FIG. 4 is an exemplary flow chart showing an exemplary process for reducing stick-slip using combined torsional and axial control according to aspects of the present disclosure.

FIG. 5 is an exemplary flow chart showing an exemplary process for reducing stick-slip using combined torsional and axial control according to aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

The systems, devices, and methods described herein describe a drilling rig apparatus that includes a controller that receives multiple inputs and provides multiple outputs. The controller may be used to assist in mitigating vibrations arising from stick-slip that occurs as torsional energy accumulates on a drill string in a wellbore during drilling operations. Embodiments of the present disclosure may automate both drill string rotary device drives (e.g., a top drive, to which reference will be made to herein for ease of discussion) speed adjustments as well as axial drive (e.g., a drive providing motion along a vertical axis of the drilling rig) speed so that the combination may more effectively mitigate stick-slip than either alone.

Embodiments of the present disclosure may utilize multiple sensors to sense parameters of the drilling rig during operation. A torque sensor senses, or derives from a sensed parameter, torque measurement data that may be provided to a controller. An operation speed of the top drive, such as rotations per minute (RPM), may be fed back to a top drive controller that may be separate from the controller receiving the torque measurement data. An operation speed of the axial drive, such as vertical speed and/or RPM where applicable, may be fed back to an axial drive controller that may similarly be separate from the controller receiving the torque measurement data. The controller receiving the torque measurement data may also receive other measurement data, including weight on bit data, differential pressure data, and speed data to name some examples.

The controller may take these measured parameters and combine at least the torque measurement data (and the other parameters in some embodiments) with values in a gain matrix. For example, a first gain may be associated with the top drive and a second gain with the axial drive. Upon combining the first gain with the measured parameters, the controller may produce a first output value. The first output value may be provided to the top drive controller, in combination with any user-provided speed changes (if any). The top drive controller may take the operation speed of the top drive and the first output value and generate a control signal to the top drive motor that results in a change to the operation (e.g., rotation) speed of the top drive.

In like manner, upon combining the second gain with the measured parameters, the controller may produce a second output value. The second output value may be provided to the axial drive controller, in combination with any user-provided speed changes (if any). The axial drive controller may take the operation speed of the axial drive and the second output value and may generate a control signal to the axial drive that results in a change to the operation speed of the axial drive. In combination, the adjustments to the top drive and axial drive movements in an automated manner mitigates stick-slip more effectively than either individually.

In some embodiments, the weight on bit may have a set limit. In that case, the controller may further compare the measured weight on bit value at a point in time to the threshold limit and, if at the limit, adjust the second gain so that the axial drive does not change its operation speed in a manner that can increase the weight on bit above the desired limit. Further, the controller may send a notification to one or more users (e.g., in real-time by an audible and/or visual signal such as a display on a user interface, by email, text message, and/or other type of alert) that may include a request to change the weight on bit limit (e.g., increase it). The controller may then implement any weight on bit limit change should such be given, or else further reduce the second gain as needed.

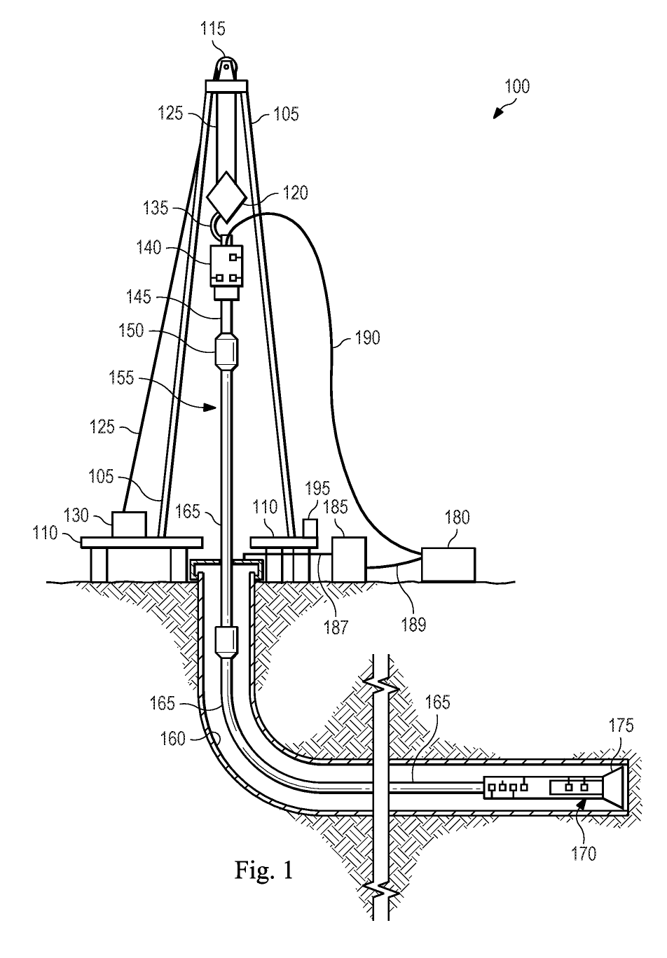

FIG. 1 is a schematic of a side view of an exemplary drilling rig apparatus 100 according to one or more aspects of the present disclosure. In some examples, the drilling rig apparatus 100 may form a part of a land-based, mobile drilling rig. However, one or more aspects of the present disclosure are applicable or readily adaptable to any type of drilling rig with supporting drilling elements, for example, the rig may include any of jack-up rigs, semisubmersibles, drill ships, coil tubing rigs, well service rigs adapted for drilling and/or re-entry operations, and casing drilling rigs, among others within the scope of the present disclosure.

The drilling rig apparatus 100 includes a mast 105 supporting lifting gear above a rig floor 110. The lifting gear may include, among other components, a crown block 115 and a traveling block 120. In this example implementation, the crown block 115 is coupled at or near the top of the mast 105, and the traveling block 120 hangs from the crown block 115 by a drilling line 125. One end of the drilling line 125 extends from the lifting gear to an axial drive 130. In an embodiment, axial drive 130 is a drawworks, which is configured to reel out and reel in the drilling line 125 to cause the traveling block 120 to be lowered and raised relative to the rig floor 110 (i.e., parallel to a vertical axis of the drilling rig apparatus 100, and hence reference to it as an “axial drive”). The other end of the drilling line 125, known as a dead line anchor, is anchored to a fixed position, possibly near the drawworks 130 or elsewhere on the rig. Other types of hoisting/lowering mechanisms may be used as axial drive 130 (e.g., rack and pinion traveling blocks as just one example). Herein, reference will be made to axial drive 130 and drawworks 130 interchangeably for ease of illustration and understanding.

In this exemplary implementation, a hook 135 is attached to the bottom of the traveling block 120. A drill string rotary device 140, of which a top drive is an example, is suspended from the hook 135. Reference will be made herein simply to top drive 140 for simplicity of discussion. A quill 145 extending from the top drive 140 is attached to a saver sub 150, which is attached to a drill string 155 suspended within a wellbore 160. Alternatively, the quill 145 may be attached to the drill string 155 directly. The term “quill” as used herein is not limited to a component which directly extends from the top drive, or which is otherwise conventionally referred to as a quill. For example, within the scope of the present disclosure, the “quill” may additionally or alternatively include a main shaft, a drive shaft, an output shaft, and/or another component which transfers torque, position, and/or rotation from the top drive or other rotary driving element to the drill string, at least indirectly. Nonetheless, albeit merely for the sake of clarity and conciseness, these components may be collectively referred to herein as the “quill.” It should be understood that other techniques for arranging a rig may not require a drilling line, and are included in the scope of this disclosure.

The drill string 155 includes interconnected sections of drill pipe 165, a bottom hole assembly (BHA) 170, and a drill bit 175. The BHA 170 may include stabilizers, drill collars, and/or measurement-while-drilling (MWD) or wireline conveyed instruments, among other components. The drill bit 175 is connected to the bottom of the BHA 170 or is otherwise attached to the drill string 155. In the exemplary embodiment depicted in FIG. 1, the top drive 140 is utilized to impart rotary motion to the drill string 155. However, aspects of the present disclosure are also applicable or readily adaptable to implementations utilizing other drive systems, such as a power swivel, a rotary table, a coiled tubing unit, a downhole motor, and/or a conventional rotary rig, among others. According to embodiments of the present disclosure, the top drive 140 may be used in combination with the axial drive 130 to reduce wellbore friction on the drill string 155 during drilling operations.

A mud pump system 180 receives the drilling fluid, or mud, from a mud tank assembly 185 and delivers the mud to the drill string 155 through a hose or other conduit 190, which may be fluidically and/or actually connected to the top drive 140. In an embodiment, the mud may have a density of at least 9 pounds per gallon. As more mud is pushed through the drill string 155, the mud flows through the drill bit 175 and fills the annulus that is formed between the drill string 155 and the inside of the wellbore 160, and is pushed to the surface. At the surface the mud tank assembly 185 recovers the mud from the annulus via a conduit 187 and separates out the cuttings. The mud tank assembly 185 may include a boiler, a mud mixer, a mud elevator, and mud storage tanks. After cleaning the mud, the mud is transferred from the mud tank assembly 185 to the mud pump system 180 via a conduit 189 or plurality of conduits 189. When the circulation of the mud is no longer needed, the mud pump system 180 may be removed from the drill site and transferred to another drill site.

The drilling rig apparatus 100 also includes a control system 195 configured to control or assist in the control of one or more components of the drilling rig apparatus 100. For example, the control system 195 may be configured to transmit operational control signals to the axial drive 130, the top drive 140, the BHA 170 and/or the mud pump system 180. The control system 195 may be a stand-alone component installed somewhere on or near the drilling rig apparatus 100, e.g. near the mast 105 and/or other components of the drilling rig apparatus 100. In some embodiments, the control system 195 is physically displaced at a location separate and apart from the drilling rig.

According to embodiments of the present disclosure, the control system 195 obtains one or more state variables, such as torque (measured or derived), differential pressure in the wellbore 160, RPM information from one or both of the top drive and axial drive, voltage and/or current information from one or both of the top drive and axial drive, weight on bit at the surface (e.g., as measured at or near the top drive 140), down-hole torque on bit at the BHA 170, down-hole RPM at the BHA 170, and down-hole weight on bit at the BHA 170 to name just a few examples. The control system 195 receives these measurements and combines them (e.g., by multiplication and/or other operations) with particular gain values that may be unique to each of the top drive 140 and the axial drive 130 as well as the drill string 155, respectively. Different values are generated and output to each of the top drive 140 and the axial drive 130, the values being used to adjust the speed of operation (e.g., adjusting RPM for the top drive 140 and axial drive 130 where it is a drawworks). Thus, for example, a first offset may be generated to adjust the RPM of the top drive 140, while a second offset is generated to adjust the operation of the axial drive 130. As a result, a combination of top drive speed and weight on bit variations is used to adjust torque/absorb torsional waves on the drill string 155/etc. so that the burden is not all assumed by the top drive 140.

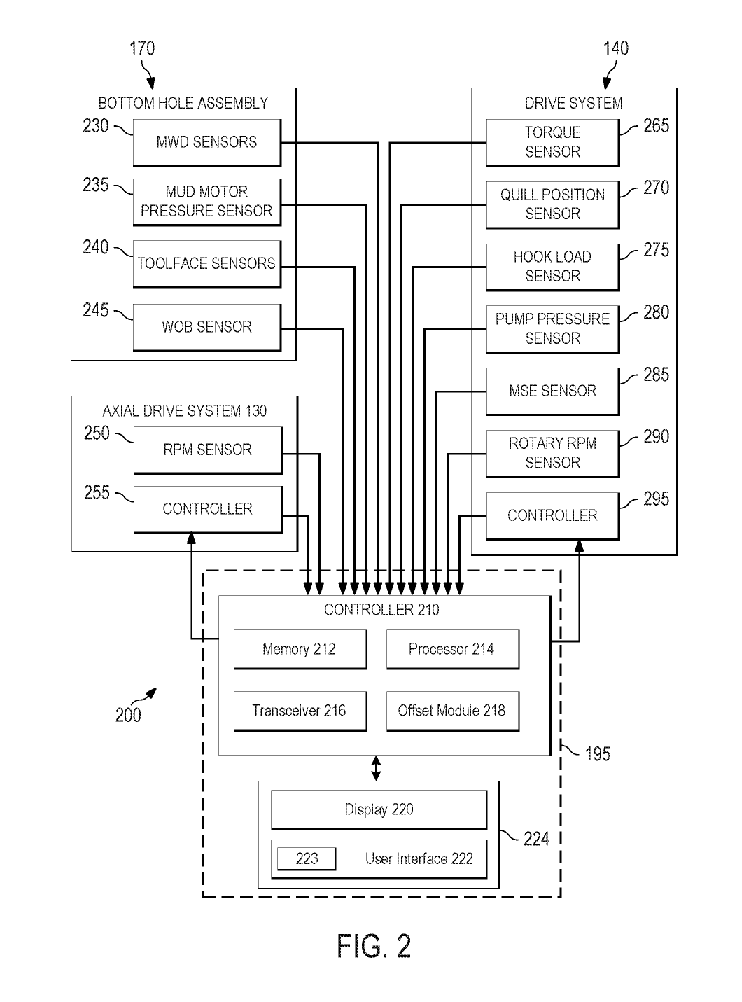

Turning to FIG. 2, a block diagram of an exemplary control configuration 200 according to one or more aspects of the present disclosure is illustrated. In an embodiment, the control configuration 200 may be described with respect to the axial drive 130, top drive 140, BHA 170, and control system 195. The control configuration 200 may be implemented within the environment and/or the apparatus shown in FIG. 1.

The control system 195 includes a controller 210 and a user interface 224. Depending on the embodiment, these may be discrete components that are interconnected via wired or wireless means. Alternatively, the user interface 224 and the controller 210 may be integral components of a single system.

The controller 210 includes a memory 212, a processor 214, a transceiver 216, and an offset module 218. The memory 212 may include a cache memory (e.g., a cache memory of the processor 214), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some embodiments, the memory 212 may include a non-transitory computer-readable medium. The memory 212 may store instructions. The instructions may include instructions that, when executed by the processor 214, cause the processor 214 to perform operations described herein with reference to the controller 210 in connection with embodiments of the present disclosure. The terms “instructions” and “code” may include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The processor 214 may have various features as a specific-type processor. For example, these may include a central processing unit (CPU), a digital signal processor (DSP), an application-specific integrated circuit (ASIC), a controller, a field programmable gate array (FPGA) device, another hardware device, a firmware device, or any combination thereof configured to perform the operations described herein with reference to the controller 210 introduced in FIG. 1 above. The processor 214 may also be implemented as a combination of computing devices, e.g., a combination of a DSP and a microprocessor, a plurality of microprocessors, one or more microprocessors in conjunction with a DSP core, or any other such configuration. The transceiver 216 may include a local area network (LAN), wide area network (WAN), Internet, satellite-link, and/or radio interface to communicate bi-directionally with other devices, such as the drill string rotary device 140, axial drive 130, BHA 170, and other networked elements.

The control system 195 also includes the user interface 224. The interface system 224 includes a display 220 and a user interface 222. The user interface 224 also includes a memory and a processor as described above with respect to controller 210. In an embodiment, the user interface 224 is separate from the controller 210, while in another embodiment the user interface 224 is part of the controller 210.

The display 220 may be used for visually presenting information to the user in textual, graphic, or video form. The display 220 may also be utilized by the user to input drilling parameters, limits, or set point data in conjunction with an input mechanism 223 of the user interface 222. For example, the input mechanism 223 may be integral to or otherwise communicably coupled with the display 220. The user interface 222 may be used to receive drill setting data, including RPM and weight on bit (e.g., as imposed by the axial drive 130) before and/or during drilling operations.

The input mechanism 223 of the user interface 222 may also be used to input additional drilling settings or parameters, such as acceleration, desired toolface orientation, toolface set points, toolface setting limits, rotation settings, and other set points or input data, including predetermined parameters that may determine the limits of oscillation. Further, a user may input information relating to the drilling parameters of the drill string 155, such as BHA 170 information or arrangement, drill pipe size, bit type, depth, formation information, and drill pipe material, among other things. These drilling parameters are useful, for example, in determining a composition of the drill string 155 to better measure and respond to torsional waves detected at the top drive 140.

The input mechanism 223 of the user interface 222 may include a keypad, voice-recognition apparatus, dial, button, switch, slide selector, toggle, joystick, mouse, data base and/or other conventional or future-developed data input device. Such a user interface may support data input from local and/or remote locations. Alternatively, or additionally, the user interface may permit user-selection of predetermined profiles, algorithms, set point values or ranges, and drill string 155 information, such as via one or more drop-down menus. The data may also or alternatively be selected by the controller 210 via the execution of one or more database look-up procedures. In general, the user interface 222 and/or other components within the scope of the present disclosure support operation and/or monitoring from stations on the rig site as well as one or more remote locations with a communications link to the system, network, local area network (LAN), wide area network (WAN), Internet, satellite-link, and/or radio, among other means.

The top drive 140 includes one or more sensors or detectors that provide information that is considered by the controller 210 when it determines how to adjust the top drive 140 and/or axial drive 130 operation to adjust torque on the drill string 155 in order to mitigate stick-slip occurrence. The top drive 140 includes a torque sensor 265 that is configured to detect a value or range of the reactive torsion of the quill 145 or drill string 155. For example, the torque sensor 265 may be a torque sub physically located between the top drive 140 and the drill string 155. As another example, the torque sensor 265 may additionally or alternative be configured to detect a value or range of torque output by the top drive 140 (or commanded to be output by the top drive 140), and derive the torque at the drill string 155 based on that measurement. This may be in the form, for example, of measuring the voltage and/or current provided from a variable frequency (VFD) drive of the top drive 140, illustrated as the controller 295 in FIG. 2, to the motor of the top drive 140. The detected voltage and/or current may be used to derive the torque at the interface of the drill string 155 and the top drive 140. The controller 295 is used to control the rotational position, speed and direction of the quill 145 or other drill string component coupled to the top drive 140 (such as the quill 145 shown in FIG. 1), shown in FIG. 2.

The top drive 140 may also include a quill position sensor 270 that is configured to detect a value or range of the rotational position of the quill, such as relative to true north or another stationary reference. The rotary torque and quill position data detected via sensors 265 and 270, respectively, may be sent via electronic signal or other signal to the controller 210 via wired or wireless transmission (e.g., to the transceiver 216). The top drive 140 may also include a hook load sensor 275, a pump pressure sensor or gauge 280, a mechanical specific energy (MSE) sensor 285, and a RPM sensor 290.

The hook load sensor 275 detects the load on the hook 135 as it suspends the top drive 140 and the drill string 155, and which may correspond to a surface weight on bit measurement. The hook load detected via the hook load sensor 275 may be sent via electronic signal or other signal to the controller 210 via wired or wireless transmission. The pump pressure sensor or gauge 280 is configured to detect the pressure of the pump providing mud or otherwise powering the down-hole motor in the BHA 170 from the surface. The pump pressure detected by the pump pressure sensor or gauge 280 may be sent via electronic signal or other signal to the controller 210 via wired or wireless transmission. The MSE sensor 285 is configured to detect the MSE representing the amount of energy required per unit volume of drilled rock. In some embodiments, the MSE is not directly sensed, but is calculated based on sensed data at the controller 210 or other controller about the drilling rig apparatus 100. The RPM sensor 290 is configured to detect the rotary RPM of the drill string 155. This may be measured at the top drive or elsewhere, such as at surface portion of the drill string 155. The RPM detected by the RPM sensor 290 may be sent via electronic signal or other signal to the controller 210 via wired or wireless transmission.

The axial drive 130 may include one or more sensors or detectors that provide information that is considered by the controller 210 when it determines how to adjust the top drive 140 and/or axial drive 130 operation to adjust torque on the drill string 155 in order to mitigate stick-slip occurrence in combination with the other inputs discussed herein.

The axial drive 130 may include an RPM sensor 250, for example where the axial drive 130 is a drawworks. In embodiments where the axial drive 130 is some other type of drive, a suitable sensor may be used to determine the speed at which the drill string 155 is hoisted or lowered. The RPM sensor 250 is configured to detect the rotary RPM of the drilling line 125, which corresponds to the speed of hoisting/lowering of the drill string 155. This may be measured at the axial drive 130. The RPM detected by the RPM sensor 250 may be sent via electronic signal or other signal to the controller 210 via wired or wireless transmission.

The axial drive 130 may also include a controller 255. The controller 255 is used to control the rotational speed of the drawworks (where that is used; more generally, to control the speed at which the drawstring is hoisted or lowered), shown in FIG. 2. Similar to the top drive 140, the controller 255 may assume the form of a VFD and receive as inputs user-selected hoisting/lowering speed changes as well as speed changes determined by the controller 210 according to embodiments of the present disclosure to mitigate stick-slip by automating a combination of top drive 140 and axial drive 130 adjustment, so that either drive is not required to do so alone.

In addition to the top drive 140 and axial drive 130, the BHA 170 may include one or more sensors, typically a plurality of sensors, located and configured about the BHA 170 to detect parameters relating to the drilling environment, the BHA 170 condition and orientation, and other information. These may provide information that is considered by the controller 210 when it determines how to adjust the top drive 140 and/or axial drive 130 operation to adjust torque on the drill string 155 in order to mitigate stick-slip occurrence in combination with the other inputs discussed above.

In the embodiment shown in FIG. 2, the BHA 170 includes MWD sensors 230. For example, the MWD sensor 230 may include a MWD casing pressure sensor that is configured to detect an annular pressure value or range at or near the MWD portion of the BHA 170. The casing pressure data detected via the MWD casing pressure sensor may be sent via electronic signal or other signal to the controller 210 via wired or wireless transmission. The MWD sensors 230 may also include an MWD shock/vibration sensor that is configured to detect shock and/or vibration in the MWD portion of the BHA 170. The shock/vibration data detected via the MWD shock/vibration sensor may be sent via electronic signal or other signal to the controller 210 via wired or wireless transmission. The MWD sensors 230 may also include an MWD torque sensor that is configured to detect a value or range of values for torque applied to the bit by the motor(s) of the BHA 170 (also referred to herein as a down-hole torque on bit sensor). The torque data detected via the MWD torque sensor may be sent via electronic signal or other signal to the controller 210 via wired or wireless transmission. The MWD sensors 230 may also include an MWD RPM sensor that is configured to detect the RPM of the bit of the BHA 170 (also referred to herein as a down-hole RPM sensor). The down-hole RPM data detected via the MWD RPM sensor may be sent via electronic signal or other signal to the controller 210 as well via wired or wireless transmission.

The BHA 170 may also include mud motor AP (differential pressure) sensor 235 that is configured to detect a pressure differential value or range across the mud motor of the BHA 170. The pressure differential data detected via the mud motor AP sensor 235 may be sent via electronic signal or other signal to the controller 210 via wired or wireless transmission. The mud motor AP may be alternatively or additionally calculated, detected, or otherwise determined at the surface, such as by calculating the difference between the surface standpipe pressure just off-bottom and pressure once the bit touches bottom and starts drilling and experiencing torque.

The BHA 170 may also include one or more toolface sensors 240. The one or more toolface sensors 240 may include a magnetic toolface sensor and a gravity toolface sensor that are cooperatively configured to detect the current toolface orientation. The magnetic toolface sensor may be or include a conventional or future-developed magnetic toolface sensor which detects toolface orientation relative to magnetic north. The gravity toolface sensor may be or include a conventional or future-developed gravity toolface sensor which detects toolface orientation relative to the Earth's gravitational field. In an exemplary embodiment, the magnetic toolface sensor may detect the current toolface when the end of the wellbore is less than about 7° from vertical, and the gravity toolface sensor may detect the current toolface when the end of the wellbore is greater than about 7° from vertical. However, other toolface sensors may also be utilized within the scope of the present disclosure that may be more or less precise or have the same degree of precision, including non-magnetic toolface sensors and non-gravitational inclination sensors. In any case, the toolface orientation detected via the one or more toolface sensors 240 may be sent via electronic signal or other signal to the controller 210 via wired or wireless transmission.

The BHA 170 may also include an MWD weight-on-bit (WOB) sensor 245 that is configured to detect a value or range of values for down-hole WOB at or near the BHA 170. The WOB data detected via the MWD WOB sensor 245 may be sent via electronic signal or other signal to the controller 210 via wired or wireless transmission.

Returning to the controller 210, the offset module 218 may be used for various aspects of the present disclosure. The offset module 218 may include various hardware components and/or software components to implement the aspects of the present disclosure. For example, in an embodiment the offset module 218 may include instructions stored in the memory 212 that causes the processor 214 to perform the operations described herein. In an alternative embodiment, the offset module 218 is a hardware module that interacts with the other components of the controller 210 to perform the operations described herein.

In an embodiment, the offset module 218 receives one or more inputs from networked elements of the controller 210. For example, the controller 210 may, via the transceiver 216, receive measured data (either raw or processed) from one or more of the sensors from the top drive 140, axial drive 130, and BHA 170. In an embodiment, the controller 210 receives the torque measurement from the torque sensor 265 of the top drive 140, while the data from the other measurements are not used for purposes of stick-slip mitigation (although they have use in other drilling aspects of the drilling rig apparatus 100 of FIG. 1). The offset module 218 obtains this received information and uses it to determine the offsets to the top drive 140 and the axial drive 130.

In this embodiment (where the controller 210 focuses reliance on the torque measurement data for stick-slip mitigation), the controller 210 uses the torque measurement data to determine two different output values: first, a speed offset calculated for the top drive 140 (e.g., an increase or decrease in RPMs for the top drive 140), and second, a speed offset calculated for the axial drive 130 (e.g., an increase or decrease in the hosting or lowering speed and/or change in direction from lowering to hoisting, etc., in a manner that modifies the resulting weight on bit at the BHA 170, which has an impact on the amount of torque on the drill string 155 in addition to the speed of the top drive 140). For example, when a spike in torque is detected (e.g., as conveyed by a torsional wave travelling the drill string 155 beginning to reach the top drive 140), the outputs from the controller 210 may cause the top drive 140 to slow its RPM and the axial drive 130 to slow its rate of penetration (e.g., as caused by the RPM of the drawworks where that is what is used). The adjustments are used to mitigate/eliminate vibration resulting from stick-slip.

The automated adjusting of both offsets (to both the top drive 140 and the axial drive 130 in some combination) thereby automates the mitigation of stick-slip by absorbing torsional waves (managing the torque on the drill string 155 at the interface with the top drive 140) in a manner that shares the load between the top drive 140 and the axial drive 130. With the combined adjustments, stick-slip mitigation becomes more effective than prior solutions that focused only on automating adjustments to the top drive 140 operation. For example, adjusting the weight on bit by changes to the axial drive 130 reduces the amount of offset required for the top drive 140 to achieve the same result, or better, of the top drive 140 modifications alone. This also results in less wear on the top drive and a potential reduction in the magnitude of any speed adjustments to RPM at the top drive 140. The speed at which the adjustments are made by the controller 210 to both offset outputs (one to the top drive 140, the other to the axial drive 130 in FIG. 2) may be much faster than the speed at which torsional waves travel along the drill string 155 between the BHA 170 and the top drive 140 (e.g., a 5 millisecond loop for the controller 210 and a 2-3 second time for the torsional waves as just one example).

In another embodiment, the controller 210 also receives additional measurement data, such as the weight on bit from the BHA 170's WOB sensor 245 and/or the weight on bit from the hook load sensor 275 from the top drive 140. The offset module 218 obtains this additional weight on bit measurement data and includes it with the torque measurement data from the top drive 140. The combined variables are used in determining the speed offset for the top drive 140 and the speed offset for the axial drive 130. For example, the offset module 218 of the controller 210 may create a linear system model and, in combination with a gain matrix that can be preset and/or dynamically modifiable, generate an offset (e.g., a movement offset, also described as a command herein) for the respective drives. For example, different gains may be associated with the top drive 140 and the axial drive 130, determined by one or more characteristics/parameters of the materials and properties of the drill string 155 in combination with the top drive 140 and the axial drive 130. The top drive 140 may receive one of the commands and the axial drive 130 the other command. In response to these commands, the controller 295 of the top drive 140 adjusts its RPM value and the controller 255 of the axial drive 130 adjusts its hosting/lowering speed (e.g., RPM where it is a drawworks), thereby actively addressing measured torque on the drill string 155 while taking into account weight on bit at the BHA 170. As another example, the controller 210 may further (e.g., in combination with the movement offsets to the top drive 140 and axial drive 130) provide a movement offset to the BHA 170 to modify the RPM of a bit at the BHA 170.

In another embodiment, the controller 210 also receives differential pressure data from one or both of the mud motor differential pressure sensor 235 and the pump pressure sensor or gauge 280 (or may be determined at the surface by the calculations mentioned above with respect to the differential pressure sensor 235). As another alternative, measurement data from a mud pump system 180 (illustrated in FIG. 1) may be provided for the differential pressure data (whether directly or derived therefrom). The differential pressure data may be useful, for example, in determining weight on bit while the drilling rig apparatus 100 is engaged in directional drilling. Thus, the differential pressure data may be used by the offset module 218 in combination with, or in the place of, the weight on bit data provided by the WOB sensor 245 discussed above.

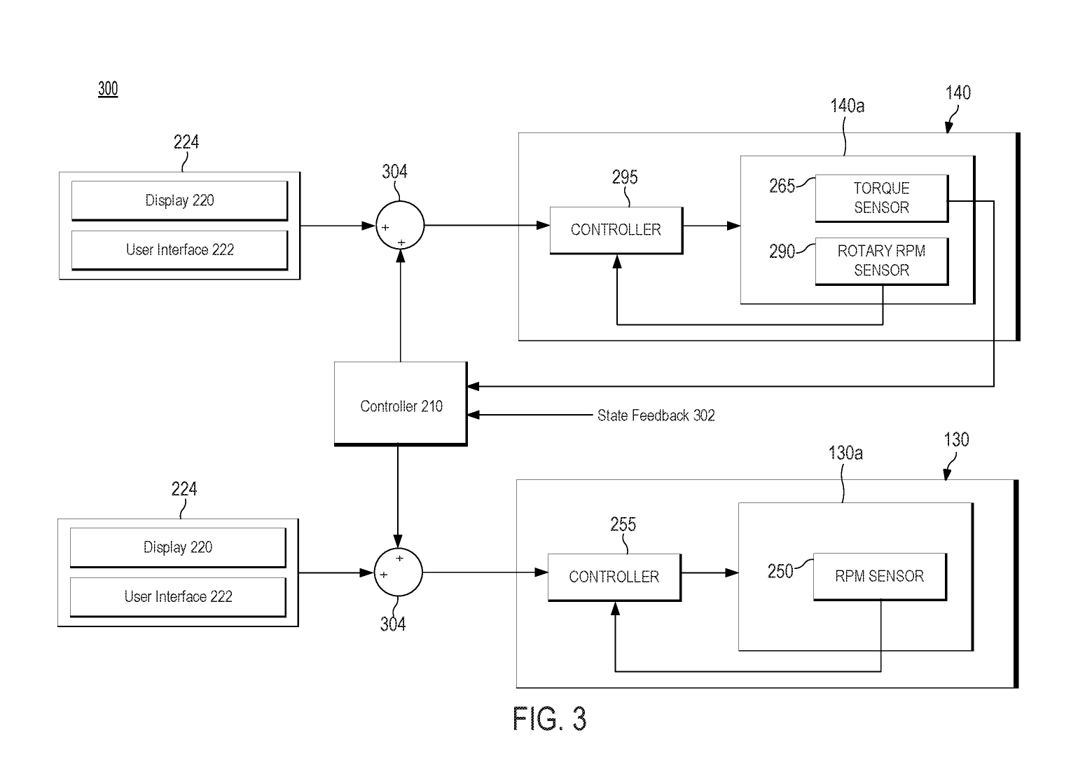

Turning now to FIG. 3, a block diagram of an exemplary control system flow 300 according to one or more aspects of the present disclosure is illustrated. The numbering continues the examples given in FIGS. 1 and 2 above, with any newly introduced elements numbered accordingly. For example, top drive 140 is illustrated with top drive moving element 140A being separate from controller 295. However, the top drive 140 may have the drive moving element 140A be in the same enclosure as the controller 295 or separate. Similarly, axial drive 130 is illustrated with axial drive moving element 130A being separate from the controller 255, though these may be in the same enclosure or separate. The drive moving elements 140A and 130A may be any of a variety of moving elements, including for example alternating current (AC) motors, direct current (DC) motors, permanent magnetic (PM) motors, mechanical brakes, hydraulic brakes, and pneumatic brakes (e.g., the brakes may be used when a slow-down of top drive RPM and/or lowering/hoisting is desired). FIG. 3 will be described as pertains to an exemplary data and command flow according to embodiments of the present disclosure.

As the top drive moving element 140A causes the drill string 155 to rotate at a designated RPM, the RPM sensor 290 provides this RPM data back to the controller 295 (e.g., a VFD). In addition, the torque sensor 265 senses/determines from other sensed parameters the torque currently at the top of the drill string 155. Similarly, as the axial drive moving element 130A causes the axial drive to axially move the drill string 155, the sensor 250 (e.g., an RPM sensor where a drawworks is used) provides the movement (e.g., as a speed or acceleration to name some examples) data back to the controller 255. The measured torque data is output from the torque sensor 265 to the controller 210 as one of the controller 210's inputs. The controller 210 may also receive one or more state feedback measurements 302 from different measurement sources, including for example the WOB measurement data from the WOB sensor 245 from BHA 170, and/or WOB measurement data derived from differential pressure measurements from mud motor differential pressure sensor 235, WOB measurement data derived from hook load sensor 275, down-hole RPM at the BHA 170, and down-hole torque on bit at the BHA, etc.

The controller 210 generates two outputs from the input data, e.g. as discussed with respect to FIG. 2. One output, determined for the top drive 140, is output to the combiner 304. Combiner 304 is illustrated as an adder. In embodiments, at any given time a user may additionally provide adjustment information via user interface 224 to adjust the rotation speed of the top drive 140. Any such adjustment may be combined with the adjustment output from the controller 210 at the combiner 304. The combined signal, e.g. an RPM command, is input to the controller 295. The controller 295, in turn, takes the RPM command as well as the RPM data provided from the RPM sensor 290 and generates a signal that is sent to the top drive moving element 140A. The signal may represent an increment change to the current RPM at the top drive moving element 140A, the absolute RPM amount desired for the top drive moving element 140A to implement, etc.

The other output, determined for the axial drive 130, is output to another combiner 304. As noted above with respect to the top drive 140, a user may input adjustment information via the same or a different user interface 224 to adjust the lowering/hoisting speed of the axial drive 130. In an embodiment, the user enters a change to a desired rate of penetration, which is then parsed out by the controller 210 or some other system of the drilling rig apparatus 100 into what adjustments are necessary at the top drive 140 and/or axial drive 130 to implement that change. The adjustment may be combined with the adjustment output from the controller 210 for the axial drive 130 at the combiner 304. The combined signal, e.g. an RPM command where the axial drive 130 is a drawworks, is input to the controller 255. The controller 255, in turn, takes the command as well as the axial movement data provided from the sensor 250 and generates a signal that is sent to the axial drive moving element 130A (e.g., an incremental change, target speed, etc.).

Although not illustrated in FIG. 3, the controller 210 may similarly output one or more offset commands to a mud pump system 180 (FIG. 1) to further influence the weight on bit to achieve a given torque adjustment and/or an RPM offset to the BHA 170. The feedback loop described above continues during drilling operations or until deactivated. Thus, to mitigate stick-slip vibration the controller 210 provides offset data to modify the speed of operation of a combination of the top drive 140 and the axial drive 130 in an automated fashion so that the burden is not all carried by the top drive 140, resulting in improved mitigation performance.

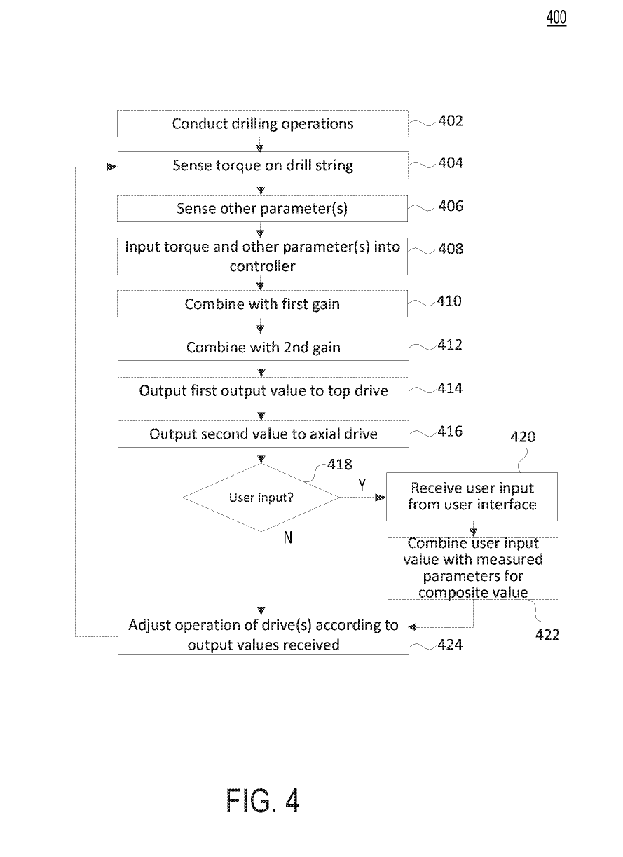

FIG. 4 is a flow chart showing an exemplary method 400 for reducing stick-slip using combined torsional and axial control according to aspects of the present disclosure. The method 400 may be performed, for example, with respect to the controller 210 and the drilling rig apparatus 100 components discussed above with respect to FIGS. 1-3. It is understood that additional steps can be provided before, during, and after the steps of method 400, and that some of the steps described can be replaced or eliminated from the method 400.

At block 402, drilling operations (whether vertical or some form of directional drilling) commence at the drilling rig apparatus 100 described in FIG. 1. For example, the drilling operations may commence according to predetermined or input commands pertaining to speed of operation/a desired rate of penetration. In the implementation described herein, the stick-slip mitigation capability may be activated in the control system 195, though it is possible for a user to deactivate the mitigation capability in the control system 195 and reactivate as desired.

At block 404, torque measurement data is obtained from the drill string 155. For example, torque measurement data is obtained by the torque sensor 265 of the top drive 140 and provided to the controller 210 for further processing. The torque measurement data may be measured directly, such as by a torque sub, or derived from another measurement, such as current provided to the drive motor in the top drive 140.

At block 406, one or more other measurement parameters may be sensed, for example surface WOB information from one or more of the hook load sensor 275 and the mud motor differential pressure sensor 235, down-hole WOB information from the WOB sensor 245, top drive RPM, top drive acceleration, top drive current, top drive voltage, down-hole torque on bit, and down-hole RPM. In some embodiments, the controller 210 relies upon torque measurement data without the other parameters.

At block 408, the torque measurement data and any additional measured parameters sensed at block 406 are input to the controller 210 for processing.

At block 410, the controller 210 combines the input measured values (torque, and other measurement parameters where included) with a first gain that has been tuned to the drill string 155 parameters for the top drive 140 to obtain a first output value. The first gain may be set to provide a predetermined level of preference for the top drive 140 to the axial drive 130—e.g., if the user desires the top drive 140 to be more responsive to torque changes to mitigate stick-slip, the first gain may be set to be higher than the second gain associated with the axial drive 130 (or vice-versa). This “predetermined level of preference” may be established prior to operation, during operation, or both.

At block 412, the controller 210 combines the input measured values (torque, and other measurement parameters where included) with a second gain that has been tuned to the drill string 155 parameters for axial drive 130 to obtain a second output value, and which may also be tunable to meet a predetermined preference for the axial drive 130 to the top drive 140. Although described as separate blocks 410 and 412, these may be performed at the same time.

At block 414, the controller 210 outputs the first output value determined from block 410, for example to the combiner 304 for the top drive 140 as illustrated in FIG. 3.

At block 416, the controller 210 outputs the second output value determined from block 412, for example to the combiner 304 for the axial drive 130 as illustrated in FIG. 3. This may be performed at the same or a different time as that at block 414. The output values (first and/or second) may represent a differential change to the existing speed at the respective drives, or may represent a target speed for the respective drives.

At decision block 418, it is determined whether any additional user data has been input, for example as described above with respect to FIG. 3. This could be in the form of a speed adjustment which could impact the top drive 140 RPM, axial drive 130 hoisting/lowering speed, or some combination of both which may be determined by one or more controllers of the drilling rig apparatus 100.

If the user has input additional user data, then the method 400 proceeds to block 420. At block 420, the additional user data is received from the user interface 222.

At block 422, the additional user data is combined with the first and second output values from blocks 414 and 416 at respective combiners 304 for the top drive 140 and axial drive 130. After combination, the first combined value is input to the top drive 140 (e.g., to the controller 295) and the second combined value is input to the axial drive 130 (e.g., to the controller 255). The method 400 then proceeds to block 424.

Returning to decision block 418, if any additional user data is not input, then the method 400 proceeds to block 424.

At block 424, the operation of the top drive 140 is adjusted in response to the first combined value (or first output value). For example, if there is a spike in torque the controller 210 may output a first output value that directs the top drive 140 to reduce its RPM to at least partially absorb the incoming torsional wave. Similarly, the controller 210 may approximately simultaneously output the second output value that directs the axial drive 130 to reduce its speed to influence the weight on bit to ease the torque on the drill string 155.

The method 400 may return back to block 404 as discussed above. This loop may continue for as long as this stick-slip method is activated at the drilling rig apparatus 100 or until drilling is completed. As noted above, the speed at which the loop in FIG. 4 performs may be much faster than the speed at which torsional waves travel along the drill string 155 between the BHA 170 and the top drive 140 (e.g., a 5 millisecond loop for the controller 210 and a 2-3 second time for the torsional waves as just one example).

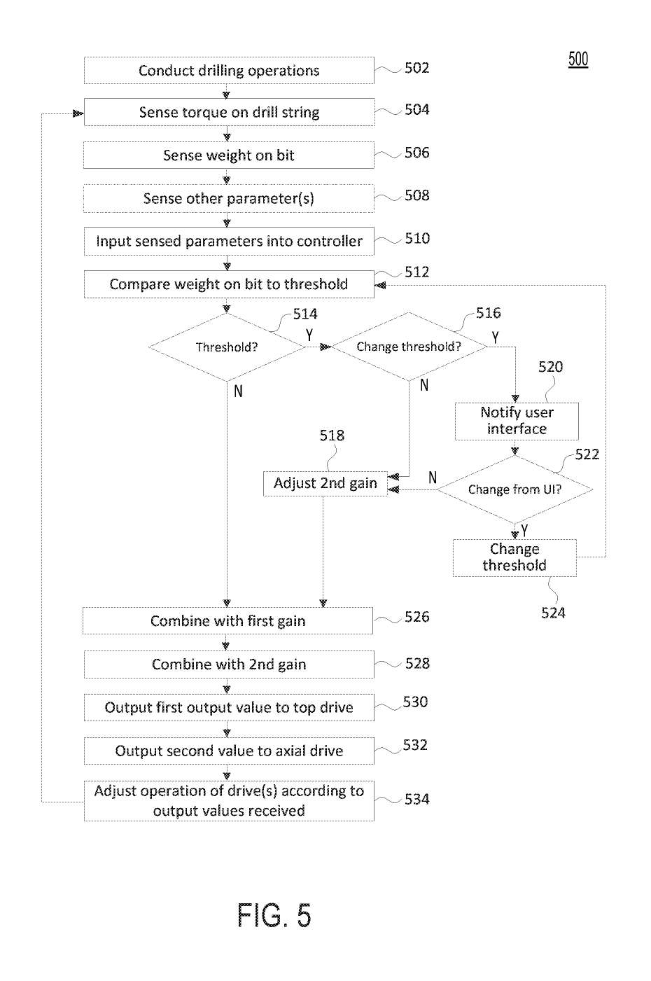

Turning now to FIG. 5, an exemplary flow chart showing an exemplary method 500 for reducing stick-slip using combined torsional and axial control according to aspects of the present disclosure. The method 500 may be performed, for example, with respect to the controller 210 and the drilling rig apparatus 100 components discussed above with respect to FIGS. 1-3. It is understood that additional steps can be provided before, during, and after the steps of method 500, and that some of the steps described can be replaced or eliminated from the method 500. Aspects of the method 500 may be combined with aspects of the method 400.

At block 502, drilling operations (whether vertical or some form of directional drilling) commence at the drilling rig apparatus 100 described in FIG. 1 and block 402 above.

At block 504, torque measurement data is obtained from the drill string 155. For example, torque measurement data is obtained by the torque sensor 265 of the top drive 140 and provided to the controller 210 for further processing. The torque measurement data may be measured directly, such as by a torque sub, or derived from another measurement, such as current provided to the drive motor in the top drive 140.

At block 506, weight on bit information is sensed by one or more sensors. For example, the hook load sensor 275 and/or the mud motor differential pressure sensor 235 may sense information that identifies the surface WOB, and the WOB sensor 245 may sense down-hole WOB at the BHA 170. Either or both surface and down-hole WOB may be sensed and/or used according to embodiments of the present disclosure.

At block 508, one or more other measurement parameters may be sensed, for example additional pressure information, RPM measurement data (surface and/or down-hole), tension data, encoder data, current data, voltage data, and/or down-hole torque on bit that may be used directly or used to derive one or more parameters in complement to the torque and WOB data.

At block 510, the torque measurement data, weight on bit data (surface and/or down-hole WOB data), and any additional measured parameters are input to the controller 210 for processing.

At block 512, the controller 210 compares the measured weight on bit information to a threshold weight on bit, e.g. a weight on bit limit. The threshold may be a default value set in the system (e.g., stored in the memory 212 of the controller 210 or some other memory), and/or may be a parameter set by a user via user interface 222. In an embodiment, the measured/derived surface WOB information is used for comparison, while in another embodiment the measured derived down-hole WOB information is used for comparison, or some combination of both (e.g., an average or a weighted average).

At decision block 514, if the result of the comparison at block 512 identifies the measured weight on bit information from block 506 as meeting (or exceeding) the threshold from the comparison, then the method 500 proceeds to decision block 516. In an alternative embodiment, the determination may be whether the measured weight on bit information falls within a set amount of the threshold.

Either way, at decision block 516 the controller 210 determines whether the threshold is allowed to be changed. This may be done by checking a flag associated with the threshold that may, when set, indicate that the threshold may be changed (or, alternatively, the set flag may identify that it may not be changed). If the threshold is not allowed to be changed, then the method 500 proceeds to block 518.

At block 518, the controller 210 adjusts the second gain (that is used to determine the second output that is sent to the axial drive 130) to reduce its contribution to the overall system. For example, in an embodiment the controller 210 may set the second gain to zero so that the axial drive 130 stops contributing to the stick-slip mitigation while at the weight on bit limit for the system.

In another embodiment, the controller 210 may set the gain to zero only after determining what the second offset would be with the previous second gain value, and determining that it would result in an increase to the weight on bit value (e.g., by increasing the lowering speed of the drill string 155)—thus, if resulting in a decrease on weight on bit, then the second gain may remain unchanged. In yet another embodiment, the controller 210 may dynamically modify the second gain based on a proximity to the threshold for weight on bit limit—the closer the measured weight on bit limit from block 506, the more the second gain is reduced, so that the impact on the weight on bit is reduced accordingly as the limit is reached (which may be combined, for example, with first determining whether the existing gain value would result in an increase on the weight on bit value if the resulting second offset were implemented).

Returning to decision block 516, if the threshold is allowed to be changed, the method 500 may proceed to block 520. At block 520, the controller 210 sends a notification to the user interface 222 for presentation to the user (e.g., as a real-time audible and/or visual display). This notification may additionally or alternatively be sent to another interface device at the drilling rig apparatus 100 or remote from the drilling rig apparatus 100, e.g. a corporate headquarters or other installation where decision making authority rests. The notification may include an identification of the measured weight on bit value at the time the notification was sent, the weight on bit limit, and a query whether the weight on bit limit may be changed. It may also include one or more preset weight on bit limit changes and/or a field for the user to manually enter a change value. Further or alternatively, the notification may include a weight on bit limit change suggestion with a yes/no prompt. From the above examples, selection of the yes/no prompt and/or selection of a preset limit change may result in the controller 210 receiving the response and automatically updating the threshold and proceeding with the method 500.

This is shown at block 522. At decision block 522, the controller 210 determines whether a threshold change has been provided/approved/etc. by the user interface 222. If not, then the method 500 proceeds to block 518 as discussed above. If an approval has been given, then the method 500 proceeds to block 524.

At block 524, the controller 210 changes the threshold according to the instruction received from the user interface 222. The method 500 then returns to block 512 to compare against the measured weight on bit (which may be the weight on bit measurement already obtained, or alternatively the method 500 may return to block 504 to obtain new measurements for all of the parameters).

Returning to decision block 514, if the weight on bit is not at the threshold (or within a set range of it or exceeding it), then the method 500 proceeds to block 526, to which the method also proceeds from block 518.

At block 526, the controller 210 combines the input measured values (torque, weight on bit, and other measurement parameters where included) with a first gain that has been tuned to the drill string 155 parameters for the top drive 140 to obtain a first output value, such as discussed above with respect to block 410 in FIG. 4.

At block 528, the controller 210 combines the input measured values (torque, weight on bit, and other measurement parameters where included) with a second gain that has been tuned to the drill string 155 parameters for axial drive 130 to obtain a second output value, and which may have been tuned as described at blocks 514-524. Although described as separate blocks 526 and 528, these may be performed at the same time.

At block 530, the controller 210 outputs the first output value determined from block 526, for example to the combiner 304 for the top drive 140 as illustrated in FIG. 3.

At block 532, the controller 210 outputs the second output value determined from block 528, for example to the combiner 304 for the axial drive 130 as illustrated in FIG. 3. This may be performed at the same or a different time as that at block 530. The output values (first and/or second) may represent a differential change to the existing speed at the respective drives, or may represent a target speed for the respective drives.

At block 534, the operation of the top drive 140 is adjusted in response to the first combined value (or first output value), such as described in block 424 above.

The method 500 may return back to block 504 as discussed above. This loop may continue for as long as this stick-slip method is activated at the drilling rig apparatus 100 or until drilling is completed. As noted above, the speed at which the loop in FIG. 5 performs may be much faster than the speed at which torsional waves travel along the drill string 155 between the BHA 170 and the top drive 140 (e.g., a 5 millisecond loop for the controller 210 and a 2-3 second time for the torsional waves as just one example).

Although the methods of FIGS. 4 and 5 have been generally described independently from each other, it will be recognized that the different methods, as well as elements of the different methods, may be combined with each other in various iterations without departing from the scope of the present disclosure.

In view of all of the above and the figures, one of ordinary skill in the art will readily recognize that the present disclosure introduces a stick-slip mitigation system, comprising: a drill string rotary drive controllable to modify a rotation speed of a drill string rotating in a direction that is transverse to an axial directional component parallel to the drill string during drilling operations; an axial drive controllable to modify a weight on bit for the axial directional component of the drill string during the drilling operations; a torque sensor configured to detect an amount of torque on the drill string based on a response to at least one of a change in the rotation speed and the weight on bit; and a controller configured to receive information, including the amount of torque from the torque sensor, and determine a first movement offset provided to the drill string rotary drive and a second movement offset provided to the axial drive based on the amount of torque, wherein the first and second movement offsets are implemented at the drill string rotary drive and axial drive, respectively, in combination to mitigate stick-slip on the drill string during the drilling operations.

The stick-slip mitigation system may include wherein the amount of torque increases in response to an increase of the weight on bit and decreases in response to a decrease of the weight on bit, the amount of torque increases in response to an increase of the rotation speed and decreases in response to a decrease of the rotation speed, and the first and second movement offsets combine to modulate the rotation speed and the weight on bit, respectively, to adjust the amount of torque to mitigate the stick-slip. The stick-slip mitigation system may also include wherein the axial drive comprises a drawworks, and the weight on bit is modifiable by adjusting a rotation speed of the drawworks, and the controller comprises a multiple input, multiple output controller. The stick-slip mitigation system may also include wherein the controller is further configured to receive one or more additional inputs included as the information comprising at least one of differential pressure, drill string rotary drive rotations per minute, surface weight on bit, drill string rotary drive acceleration, drill string rotary drive current, drill string rotary drive voltage, down-hole rotations per minute, down-hole torque on bit, and down-hole weight on bit, and determine the first and second movement offsets based on a combination of the inputs in the information including the one or more additional inputs. The stick-slip mitigation system may also include wherein the controller comprises a closed loop system, and a completion time of the closed loop system is less than a travel time of a torsional wave from the drill string detected as the amount of torque at the torque sensor. The stick-slip mitigation system may also include wherein the information further comprises at least one of a down-hole weight on bit received from a bottom hole assembly coupled to the drill string and a surface weight on bit, and the controller is further configured, as part of the determination, to compare the at least one of the down-hole weight on bit and the surface weight on bit to a threshold weight on bit value. The stick-slip mitigation system may also include wherein the controller is further configured to reduce, in response to the comparison identifying the at least one of the down-hole weight on bit and the surface weight on bit as equaling the threshold weight on bit value, a gain associated with the axial drive to reduce a contribution of the second movement offset to mitigate stick-slip on the drill string. The stick-slip mitigation system may also include wherein the first movement offset is determined from a combination of the detected amount of torque and a first gain, the second movement offset is determined from a combination of the detected amount of torque and a second gain, and the first gain and the second gain is each tuned to at least one parameter of the drill string.

The present disclosure also includes a method for mitigating stick-slip on a drill string, comprising: receiving, by a controller, torque on the drill string detected by a torque sensor, the torque being based on a response to a change in at least one of a rotation speed of a drill string rotary drive and a weight on bit of the drill string imposed by an axial drive; generating, by the controller, a first movement offset based on the torque and a first gain associated with the drill string rotary drive and a second movement offset based on the torque and a second gain associated with the axial drive; and sending, from the controller, the first movement offset to the top drive for implementation to modify the rotation speed and the second movement offset to the axial drive for implementation to modify the weight on bit, to mitigate the stick-slip on the drill string during drilling operations.

The method may include wherein the generating further comprises increasing, by the controller, a combination of the first movement offset and the second movement offset to increase torque on the drill string, and decreasing, by the controller, the combination of the first movement offset and the second movement offset to decrease torque on the drill string. The method may also include receiving, at the controller, one or more additional inputs including differential pressure, drill string rotary drive rotations per minute, surface weight on bit, drill string rotary drive acceleration, drill string rotary drive current, drill string rotary drive voltage, down-hole rotations per minute, down-hole torque on bit, and down-hole weight on bit, and determining, by the controller, the first movement offset and the second movement offset based on a combination of the one or more additional inputs and the torque. The method may also include wherein the controller comprises a closed loop system, and a completion time of the closed loop system is less than a travel time of a torsional wave from the drill string detected as the torque at the torque sensor. The method may also include receiving at least one of a down-hole weight on bit measurement from a bottom hole assembly coupled to the drill string and a surface weight on bit measurement from a load sensor associated with the drill string rotary drive, and comparing, by the controller, the at least one of the down-hole weight on bit measurement and the surface weight on bit measurement with a threshold weight on bit amount. The method may also include reducing, by the controller in response to the threshold weight on bit amount being met, the second gain to reduce a contribution of the second movement offset to mitigate stick-slip on the drill string. The method may also include wherein the torque is detected by the torque sensor detecting a current provided to a motor in the drill string rotary drive and the torque is derived from the detected current in the drill string rotary drive.

The present disclosure also introduces a non-transitory machine-readable medium having stored thereon machine-readable instructions executable to cause a machine to perform operations comprising receiving a detected amount of torque on a drill string at an interface of the drill string and a drill string drive; determining a first movement offset corresponding to a rotation speed of the drill string drive and a second movement offset corresponding to a weight on bit controlled by an axial drive, each based on the detected amount of torque; and sending the determined first movement offset to the drill string drive to adjust the rotation speed and the determined second movement offset to the axial drive to adjust the weight on bit, a combination of the adjustment to the rotation speed and the weight on bit mitigating stick-slip on the drill string during drilling operations.

The non-transitory machine-readable medium may include receiving a plurality of inputs including the detected amount of torque and at least one of a detected surface weight on bit, differential pressure, drill string drive rotations per minute, a detected down-hole weight on bit, drill string drive acceleration, drill string drive current, drill string drive voltage, down-hole rotations per minute, and down-hole torque on bit, and determining the first movement offset and the second movement offset based on a combination of the detected amount of torque and one or more of the plurality of inputs. The non-transitory machine-readable medium may also include receiving a differential pressure amount, and estimating a surface weight on bit used in determining the second movement offset based on the received differential pressure amount. The non-transitory machine-readable medium may also include determining the first movement offset based on a combination of the detected amount of torque and a first gain associated with the drill string drive, and determining the second movement offset based on a combination of the detected amount of torque and a second gain associated with the axial drive. The non-transitory machine-readable medium may also include modifying the first gain, the second gain, or some combination thereof to adjust a level of contribution that the drill string drive and the axial drive provide in response to the detected amount of torque on the drill string.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

Moreover, it is the express intention of the applicant not to invoke 35 U.S.C. §112(f) for any limitations of any of the claims herein, except for those in which the claim expressly uses the word “means” together with an associated function.

What is claimed is:

1. A stick-slip mitigation system, comprising:
a drill string rotary drive controllable to modify a rotation speed of a drill string rotating in a direction that is transverse to an axial directional component parallel to the drill string during drilling operations;
an axial drive controllable to modify a weight on bit for the axial directional component of the drill string during the drilling operations;
a torque sensor configured to detect an amount of torque on the drill string based on a response to at least one of a change in the rotation speed and the weight on bit; and
a controller configured to receive information, including the amount of torque from the torque sensor, and determine a first movement offset provided to the drill string rotary drive and a second movement offset provided to the axial drive based on the amount of torque, wherein the first and second movement offsets are implemented at the drill string rotary drive and axial drive, respectively, in combination to mitigate stick-slip on the drill string during the drilling operations.

2. The stick-slip mitigation system of claim 1, wherein:
the amount of torque increases in response to an increase of the weight on bit and decreases in response to a decrease of the weight on bit;
the amount of torque increases in response to an increase of the rotation speed and decreases in response to a decrease of the rotation speed; and
the first and second movement offsets combine to modulate the rotation speed and the weight on bit, respectively, to adjust the amount of torque to mitigate the stick-slip.

3. The stick-slip mitigation system of claim 2, wherein:
the axial drive comprises a drawworks, and the weight on bit is modifiable by adjusting a rotation speed of the drawworks, and
the controller comprises a multiple input, multiple output controller.

4. The stick-slip mitigation system of claim 1, wherein the controller is further configured to:
receive one or more additional inputs included as the information comprising at least one of differential pressure, drill string rotary drive rotations per minute, surface weight on bit, drill string rotary drive acceleration, drill string rotary drive current, drill string rotary drive voltage, down-hole rotations per minute, down-hole torque on bit, and down-hole weight on bit; and
determine the first and second movement offsets based on a combination of the inputs in the information including the one or more additional inputs.

5. The stick-slip mitigation system of claim 1, wherein:
the controller comprises a closed loop system; and
a completion time of the closed loop system is less than a travel time of a torsional wave from the drill string detected as the amount of torque at the torque sensor.

6. The stick-slip mitigation system of claim 1, wherein:
the information further comprises at least one of a down-hole weight on bit received from a bottom hole assembly coupled to the drill string and a surface weight on bit; and
the controller is further configured, as part of the determination, to compare the at least one of the down-hole weight on bit and the surface weight on bit to a threshold weight on bit value.

7. The stick-slip mitigation system of claim 6, wherein the controller is further configured to:
reduce, in response to the comparison identifying the at least one of the down-hole weight on bit and the surface weight on bit as equaling the threshold weight on bit value, a gain associated with the axial drive to reduce a contribution of the second movement offset to mitigate stick-slip on the drill string.

8. The stick-slip mitigation system of claim 1, wherein:
the first movement offset is determined from a combination of the detected amount of torque and a first gain;
the second movement offset is determined from a combination of the detected amount of torque and a second gain; and
the first gain and the second gain is each tuned to at least one parameter of the drill string.

9. A method for mitigating stick-slip on a drill string, comprising:
receiving, by a controller, torque on the drill string detected by a torque sensor, the torque being based on a response to a change in at least one of a rotation speed of a drill string rotary drive and a weight on bit of the drill string imposed by an axial drive;
generating, by the controller, a first movement offset based on the torque and a first gain associated with the drill string rotary drive and a second movement offset based on the torque and a second gain associated with the axial drive; and
sending, from the controller, the first movement offset to the drill string rotary drive for implementation to modify the rotation speed and the second movement offset to the axial drive for implementation to modify the weight on bit, to mitigate the stick-slip on the drill string during drilling operations.

10. The method of claim 9, wherein the generating further comprises:
increasing, by the controller, a combination of the first movement offset and the second movement offset to increase torque on the drill string; and
decreasing, by the controller, the combination of the first movement offset and the second movement offset to decrease torque on the drill string.

11. The method of claim 9, further comprising:
receiving, at the controller, one or more additional inputs including differential pressure, drill string rotary drive rotations per minute, surface weight on bit, drill string rotary drive acceleration, drill string rotary drive current, drill string rotary drive voltage, down-hole rotations per minute, down-hole torque on bit, and down-hole weight on bit; and
determining, by the controller, the first movement offset and the second movement offset based on a combination of the one or more additional inputs and the torque.

12. The method of claim 9, wherein:
the controller comprises a closed loop system; and
a completion time of the closed loop system is less than a travel time of a torsional wave from the drill string detected as the torque at the torque sensor.

13. The method of claim 9, further comprising:
receiving at least one of a down-hole weight on bit measurement from a bottom hole assembly coupled to the drill string and a surface weight on bit measurement from a load sensor associated with the drill string rotary drive; and
comparing, by the controller, at least one of the down-hole weight on bit measurement and the surface weight on bit measurement with a threshold weight on bit amount.

14. The method of claim 13, further comprising:
reducing, by the controller in response to the threshold weight on bit amount being met, the second gain to reduce a contribution of the second movement offset to mitigate stick-slip on the drill string.

15. The method of claim 9, wherein the torque is detected by the torque sensor detecting a current provided to a motor in the drill string rotary drive, and the torque is derived from the detected current in the drill string rotary drive.

16. A non-transitory machine-readable medium having stored thereon machine-readable instructions executable to cause a machine to perform operations comprising:
receiving a detected amount of torque on a drill string at an interface of the drill string and a drill string drive;
determining a first movement offset corresponding to a rotation speed of the drill string drive and a second movement offset corresponding to a weight on bit controlled by an axial drive, each based on the detected amount of torque; and
sending the determined first movement offset to the drill string drive to adjust the rotation speed and the determined second movement offset to the axial drive to adjust the weight on bit, a combination of the adjustment to the rotation speed and the weight on bit mitigating stick-slip on the drill string during drilling operations.

17. The non-transitory machine-readable medium of claim 16, the operations further comprising:
receiving a plurality of inputs including the detected amount of torque and at least one of a detected surface weight on bit, differential pressure, drill string drive rotations per minute, a detected down-hole weight on bit, drill string drive acceleration, drill string drive current, drill string drive voltage, down-hole rotations per minute, and down-hole torque on bit; and
determining the first movement offset and the second movement offset based on a combination of the detected amount of torque and one or more of the plurality of inputs.

18. The non-transitory machine-readable medium of claim 16, the operations further comprising:
receiving a differential pressure amount; and
estimating a surface weight on bit used in determining the second movement offset based on the received differential pressure amount.

19. The non-transitory machine-readable medium of claim 16, the operations further comprising:
determining the first movement offset based on a combination of the detected amount of torque and a first gain associated with the drill string drive; and
determining the second movement offset based on a combination of the detected amount of torque and a second gain associated with the axial drive.

20. The non-transitory machine-readable medium of claim 19, the operations further comprising:
modifying the first gain, the second gain, or some combination thereof to adjust a level of contribution that the drill string drive and the axial drive provide in response to the detected amount of torque on the drill string.
